(19) United States
(12) Patent Application Publication
(10) Pub. No.: US 2015/0006319 A1
(43) Pub. Date: Jan. 1, 2015

(54) SYSTEM AND METHOD FOR COMMUNICATION AND PROCESSING BETWEEN DEVICES AND OBJECTS

(71) Applicant: Barkley, Inc., Kansas City, MO (US)

(72) Inventors: Alan THOMAS, Kansas City, MO (US); Chris RIEBSCHLAGER, Kansas City, MO (US); Julie SIKONSKI, Kansas City, MO (US); Jessica PINE, Independence, MO (US); Matt BENJAMIN, Kansas City, MO (US); Gabrielle SCHOCK, Overland Park, KS (US); Rachel HATHAWAY, Kansas City, MO (US); Kelly STRODA, Lawrence, KS (US)

(73) Assignee: BARKLEY, INC., Kansas City, MO (US)

(21) Appl. No.: 14/316,335

(22) Filed: Jun. 26, 2014

Related U.S. Application Data
(60) Provisional application No. 61/839,745, filed on Jun. 26, 2013.

(51) Int. Cl. G06Q 30/06

(52) U.S. Cl. CPC G06Q 30/0633
USPC 705/26.8

(57) ABSTRACT

Systems and methods provide guidance and recommendations regarding objects located in an establishment and facilitate transactions involving the objects. Information regarding the objects can be searched, object locations are determined, a patron's location is determined, and directions to the objects from the patron's location is provided. Suggestions of objects for the patron are determined partly based on the patron's location in the establishment.

### RELATED APPLICATIONS

The present non-provisional patent application claims priority of an earlier-filed provisional patent application titled SYSTEM AND METHOD FOR COMMUNICATION AND PROCESSING BETWEEN DEVICES AND OBJECTS, Ser. No. 61/839,745, filed Jun. 26, 2013. The contents of the identified earlier-filed application are hereby incorporated by reference into the present application.

### BACKGROUND

The present invention relates generally to systems and methods for communication and processing between devices and objects, and more particularly to systems and methods that, based on user information and/or product information, provide guidance and recommendations regarding the objects to a user of the systems and methods, and facilitate transactions involving the objects.

Shoppers often use shopping lists to aid in recalling desired items. A shopper may refer to the list to determine the location in a retail establishment of a desired item. To locate a desired item in the establishment, such as a grocery or department store, the shopper may rely on his memory and/or refer to signage at a retailer to locate the desired item. The shopper may navigate to the desired item by traversing throughout the store to finally arrive at location of the desired item by happenstance. Given a list of desired items, the shopper must manually determine the shortest route to obtain all of the desired items. Moreover, a shopper may arrive at the location of where an item should be, but the item is out of stock. In many cases, the shopper may expend a longer time than desired to locate a desired item.

Once located, the desired item may be placed into a shopping container, such as a basket or a cart. Subsequent items may be located and placed into the container. The shopper must manually “cross off” items on his shopping list as each item is successively located and placed into the container. Suggestions of items to purchase based on purchase history, location of the user within the store, items on the shopping list, friend's recommendations, newer, healthier, or lower cost alternatives, and various other attributes, are not easily presented to the user during his shopping session.

The shopper ultimately engages in a purchase or checkout transaction, often at a point-of-sale system. Either the retailer's personnel or the shopper himself must manually register each item with a point of sale system, often by scanning the barcode of the item. The checkout transaction normally includes the shopper paying the retailer for the items purchased.

A store manager may use on-shelf inventory to determine items that may need to be replenished before the regular re-stocking of the shelves, but the manager typically does not have this information as the items are removed by shoppers. Empty shelves may result in shopper frustration when the shopper must summon the store's personnel, and wait for the personnel to determine availability to re-stock. Empty shelves may also result in lost sales when those shoppers seek the item at another store, delay the purchase, or simply abandon the purchase of the item.

The placement of items in a retail establishment often takes into account information such as surveys, studies, and other observations in an effort to increase sales. The information regarding the path that a shopper takes to obtain desired items, the amount of time the shopper stops in given areas, and what items the shopper ultimately purchases with respect to the path and time spent is not available for use in determining ideal placement of items.

### SUMMARY

According to an aspect, a system for communication and processing between devices and objects is provided, the system comprising at least one processor, a memory, at least one list, and a list module executable with the at least one processor, wherein the at least one list comprises a plurality of entries; the entries are references to objects; the at least one list is stored in the memory; and the list module is configured to manage the at least one list.

In some embodiments, the management of the at least one list comprises creating a new list, revising a list, deleting a list, importing a list, sharing a list, and subscribing to a list, wherein all lists are stored in the memory. In one embodiment, the list module enables a user to subscribe to another user's list. According to another embodiment, the system further comprises a quantity attribute associated with each entry of a list, wherein the list module further enables a user to update each entry's quantity attribute. In one embodiment, the system further comprises a status attribute associated with each entry, wherein the list module is further configured to update the status of an entry.

According to one embodiment of the system, the list module is further configured to receive information about objects physically present in the establishment. In some embodiments, the list module is configured to receive the information about the objects via an optical device. According to an embodiment, the information is encoded in an image acquirable by the optical device. One embodiment of such an image is a bar code, and another embodiment is a QR code. In an aspect of the system, the list module is further configured to receive the information via a wireless signal. The wireless signal may be selected from a group comprising near field communication (NFC), radio frequency identification (RFID), Wi-Fi, Bluetooth, etc.

In one aspect of the system, the list module is further configured to automatically update the status of a list entry based on the received information. The list module may further enable a user to update the status of a list entry. In some embodiments, the status can indicate either that an item has already been obtained (by, for example, an “in-cart” status) or that an item is still needed. The system may further comprise a total dollar amount equal to the sum of the cost of all list entries having an in-cart status, wherein the list module is further configured to update the total dollar amount based on a status update of a list entry.

In some embodiments, the system further comprises a checkout module executable on the at least one processor, and a checkout bay comprising at least one or more object detectors, wherein the bay is configured to enable association with a shopping container, to enable detection of individual objects in the shopping container; and to communicate to the checkout module, and wherein the checkout module is configured to present to the user the list of objects having an in-cart status, the price of each such object, and the total cost of the objects that have an in-cart status; to receive from the checkout bay a list of objects detected to be in the container; to identify discrepancies between the list of objects having an in-cart status and the list of detected objects; to present any discrepancies to the user; and to receive from the user any adjustments to the list of objects having an in-cart status.

According to an embodiment, the checkout module of the system is further configured to receive payment via the user's device. The method of payment received may be selected from the group comprising an electronic wallet, stored payment profile, NFC, electronic check, and payment processors. In one aspect, the type of object detectors of the checkout bay is selected from the group comprising RFID reader, barcode scanner, and digital image sensor.

The system, in some embodiments, further comprises an inventory database stored in memory, and a search module executable with the at least one processor, wherein the database comprises information about objects that an establishment can offer, and the search module is configured to search the inventory database for the information about the objects. In an embodiment, the system further comprises search criteria supplied by a user, wherein the search of the inventory database is based on the user-supplied search criteria. In some embodiments, the user-supplied criteria comprises at least one entry from the at least one list. According to another aspect, the system further comprises pre-determined search criteria stored in the memory, wherein the search of the inventory is based on the pre-determined search criteria. In some embodiments, the pre-determined criteria may be based in part on at least one of a user's purchase history, the user's location within the establishment, the user's list of objects, the user's friends' recommendations, and other objects related to objects in the user's list.

According to some embodiments, the system further comprises search results, namely, a list of entries comprising references to those objects found by the search, wherein the list module is further configured to present the search results to the user. In some embodiments, the inventory database further comprises location information for each resulting entry, and the search results include the location information for each entry in the list. According to one embodiment, the list module is configured to present to the user the location information for each entry in the search results. In some embodiments, the location information is presented graphically.

According to another aspect, a system for communication and processing between devices and objects is provided, the system comprising at least one processor, a memory, a pairing module executable by the at least one processor, wherein the pairing module is configured to receive an identification of a user's device, to receive a first identification of a shopping container, to receive a second identification of the shopping container via the user's device, to create an association between the identification of the user's device with the shopping container, and to store in the memory the identification of the user's device, the two identifications of the shopping container, and the association.

In one embodiment, the system further comprises an RFID reader, and an RFID tag affixed to the shopping container, wherein the RFID tag is configured to transmit the first identification, and the RFID reader is configured to receive the first identification transmitted by the RFID tag when the tag is in range, and to communicate with the pairing module. In an embodiment, the RFID reader is configured to communicate wirelessly with the pairing module. In another embodiment, the system further comprises a barcode affixed to the shopping container wherein the second identification is encoded in the barcode, and the second identification is acquired by an optical component of the user's device before the second identification is received by the pairing module.

In some embodiments, the system further comprises a plurality of RFID readers located throughout an establishment, wherein each RFID reader is configured to read information transmitted by the RFID tag affixed to the shopping container when the tag is in range, and to communicate with the pairing module, wherein the pairing module is configured to 1) receive RFID tag information via the plurality of RFID readers, and 2) determine the approximate location of the user based on: the location of one of the plurality of RFID readers that read the information transmitted by the RFID tag affixed to the shopping container; the user's device's identification; the shopping container's RFID tag information; and the shopping container's barcode information.

According to another embodiment, a system for communication and processing between devices and objects is provided, the system comprising at least one processor, a memory, a user location module executable by the at least one processor, wherein the location module is configured to determine the approximate location of the user within an establishment. In some embodiments, the user location module is further configured to receive global positioning system (GPS) information via a user's device, and to determine the user's approximate location based on the received GPS information.

In some embodiments, the user location module is configured to receive visible light communications (VLC) information via a user's device, and to determine the user's approximate location based on the received VLC information. In other embodiments, the system comprises a plurality of RFID readers located throughout an establishment, wherein each RFID reader is configured to read information transmitted by an RFID tag affixed to a shopping container when the tag is in range, and to communicate with the user location module, wherein the user location module is configured to receive RFID tag information via the plurality of RFID readers, and to determine the approximate location of the user based on: the location of one of the plurality of RFID readers that read the information transmitted by the RFID tag affixed to the shopping container, and information that pairs a user's device with the shopping container.

According to an embodiment, the system further comprises an inventory database stored in the memory and contains information about objects that an establishment can offer, and a suggestions module executable on the at least one processor, wherein the suggestions module is configured to search the inventory database for objects, and the search for objects is based in part on the approximate location of the user within the establishment. In other embodiments, the information about objects further comprises location information for each object in the inventory database, and the user location module is further configured to receive a list of object entries from the user, to retrieve the location information from the inventory database for the object entries, and to present to the user the location information for each of the object entries.

In some embodiments, the user location module is further configured to determine the navigation directions to the location of each of the object entries starting from the determined approximate user's location, and to present the navigation directions to the user. In one embodiment, the user location module is further configured to determine a navigation route to the locations of each of the objects in series, and to present the navigation route to the user.

According to another aspect, a method for communication and processing between devices and objects is provided, the method comprising providing at least one processor, a memory, and at least one list, and configuring the at least one processor to manage the at least one list, wherein each list comprises entries, which are references to objects, and the at least one list is stored in the memory. In an embodiment of the method, the managing of the at least one list comprises configuring the at least one processor to create a new list, revise a list, delete a list, import a list, share a list, and subscribe to a list, wherein all lists are stored in the memory.

In some embodiments, the method further comprises configuring the at least one processor to subscribe to another user's list. In other embodiments, the method further comprises providing a quantity attribute associated with each entry of a list, and configuring the at least one processor to update each entry's quantity attribute. According to an embodiment, the method further comprises providing a status attribute associated with each entry of a list, and configuring the at least one processor to update the status of an entry. In some embodiments, the method further comprises configuring the at least one processor to receive information about objects physically present in the establishment. The method may further comprise configuring the at least one processor to receive the information via an optical device. The information may be encoded in an image acquirable by the optical device. In some embodiments, the image is a barcode, and in other embodiments, the image is a QR code. The method may further comprise configuring the at least one processor to receive the information via wireless signal, and the wireless signal may be selected from a group comprising near field communication (NFC), radio frequency identification (RFID), Wi-Fi, and Bluetooth.

According to other aspects, the method may further comprise configuring the at least one processor to automatically update the status of an entry based on the received information. The method may further comprise configuring the at least one processor to update the status of an object entry as in-cart or still-need. In one embodiment, the method further comprises providing a total dollar amount reflecting the sum of the cost of all object entries having an in-cart status, and configuring the at least one processor to update the total dollar amount based on a status update of a list entry.

In some embodiments, the method further comprises providing a checkout bay comprising at least one or more object detectors, configuring the at least one processor to: associate the bay with the shopping container; detect each of the objects in the shopping container; present to the user the list of objects having an in-cart status, the price of each such object, and the total cost of the objects that have an in-cart status; receive from the checkout bay a list of detected objects; identify discrepancies between the list of objects having an in-cart status and the list of detected objects; present any discrepancies to the user; and receive from the user any adjustments to the list of objects having an in-cart status.

In some aspects, the method further comprises configuring the at least one processor to receive payment via the user's device. The method of payment received is selected from the group comprising electronic wallet, stored payment profile, NFC, electronic check, and payment processors. The type of the at least one object detectors is selected from a group comprising RFID, barcode scanner, and digital image sensors.

According to some embodiments, the method further comprises providing an inventory database stored in the memory, and configuring the at least one processor to search the inventory database for the information about the objects, wherein the database comprises information about objects that an establishment can offer. In one aspect, the method further comprises providing search criteria specified by a user, and configuring the at least one processor to search the inventory database based on the user-specified search criteria. The user-specified criteria in one embodiment comprises at least one entry from the at least one list. According to other embodiments, the method comprises providing pre-determined search criteria stored in the memory, and configuring the at least one processor to search for objects based on the pre-determined search criteria. The pre-determined search criteria may be based in part on at least one of: a user's purchase history, the user's location within the establishment, the user's list of objects, the user's friends' recommendations, and other objects related to objects in the user's list.

In some embodiments, the method further comprises providing a results list of entries comprising references to those objects found by the search, and configuring the at least one processor to present the results list to the user. The inventory database may further comprise location for each object entry in the results list. The method may further comprise configuring the at least one processor to present to the user the location information for each object entry in the results list. The method may further comprise configuring the at least one processor to present the location information graphically.

According to other embodiments, a method for communication and processing between devices and objects is provided, the method comprising providing at least one processor, and a memory, and configuring the at least one processor to receive an identification of a user's device, receive a first identification of a shopping container, receive a second identification of the shopping container via the user's device, create an association between the identification of the user's device with the shopping container, and store in the memory the identification of the user's device, the two identifications of the shopping container, and the association. The method may further comprise providing a radio frequency identification (RFID) reader, providing a RFID tag affixed to the shopping container, configuring the RFID tag to transmit the first identification, and configuring the RFID reader to 1) read the first identification transmitted by the RFID tag when the tag is in range, and 2) communicate with the at least one processor. The method may further comprise configuring the RFID to communicate wirelessly with the at least one processor.

In some embodiments, the method further comprises providing a barcode affixed to the shopping container, wherein the second identification is encoded in the barcode, and acquiring the second identification by an optical component of the user's device before the second identification is received by the at least one processor. In other embodiments, the method further comprises providing a plurality of RFID readers located throughout an establishment; configuring each RFID reader to 1) read information transmitted by the RFID tag affixed to the shopping container when the tag is in range, and 2) communicate with the at least one processor; configuring the at least one processor to receive RFID tag information via the plurality of RFID readers; and configuring the at least one processor to determine the approximate location of the user based on the location of one of the plurality of RFID readers that read the information transmitted by the RFID tag affixed to the shopping container, the user's device's identification, the shopping container's RFID tag information, and the shopping container's barcode information.

According to some embodiments, a method for communication and processing between devices and objects is provided, the method comprising providing at least one processor, providing a memory, configuring the at least one processor to determine the approximate location of the user within an establishment. In one embodiment, the method further comprises configuring the at least one processor to receive global positioning system (GPS)information via a user's device, and determine the user's approximate location based on the received GPS information. In another embodiment, the method further comprises configuring the at least one processor to receive visible light communications (VLC) information via a user's device, and to determine the user's approximate location based on the received VLC information. In some embodiments, the method further comprises providing a plurality of RFID readers locate throughout an establishment; configuring each RFID reader to 1) read information transmitted by an RFID tag affixed to a shopping container when the tag is in range, and 2) communicate with the at least one processor; configuring the at least one processor to receive RFID tag information via the plurality of RFID readers, and to determine the approximate location of the user based on 1) the location of one of the plurality of RFID readers that read the information transmitted by the RFID tag affixed to the shopping container, and 2) information pairing a user's device with the shopping container.

In other embodiments, the method further comprises providing an inventory database stored in the memory, configuring the at least one processor to search the inventory database for objects based in part on the approximate location of the user within the establishment, wherein the database contains information about objects that an establishment can offer. According to some embodiments, the method further comprises providing an inventory database stored in the memory, wherein the database comprises information about objects that the establishment can offer; and configuring the at least one processor to 1) receive a list of object entries from the user, 2) retrieve the location information from the inventory database for the object entries, and 3) present to the user the location information for each of the object entries. In an embodiment, the method further comprises configuring the processor to determine the navigation directions to the location of each of the object entries starting from the determined approximate user's location, and to present the navigation directions to the user. In other embodiments, the method further comprises configuring the at least one processor to determine a navigation route starting from the determined approximate user's location to the locations of each of the objects in series, and to present the navigation route to the user.

### BRIEF DESCRIPTION OF THE DRAWINGS

The drawings constitute a part of this specification and include exemplary embodiments of the disclosed subject matter and illustrate various objects and features thereof.

FIG. 1 is an embodiment of the disclosed subject matter.

FIG. 2 is diagram illustrating aspects of the disclosed subject matter.

FIG. 3 is an example of the disclosed subject matter.

FIG. 4 is a diagram of aspects of the disclosed subject matter.

FIG. 5 is a diagram of aspects of the disclosed subject matter.

FIG. 6 is an illustration of an embodiment of the disclosed subject matter.

FIG. 7 is an illustration of an embodiment of the disclosed subject matter.

### DETAILED DESCRIPTION

It is desirable to create a seamless, more accurate, and more efficient experience for the shopper in a retail establishment, such that the shopper using a familiar and/or personal device may use shopping lists accurately, locate desired items and other destinations efficiently, receive relevant and timely suggestions regarding items for purchase, and checkout and pay for the items with little manual intervention. It is further desirable to create marketing opportunities for the retail establishment, such that the information regarding the shopper's shopping habits provides the ability to identify, even during the shopper's shopping session, items that may be relevant and/or timely for the shopper to purchase, based on the shopper's purchase history, his location within the establishment, his shopping list, his friends' recommendations, newer, healthier, or lower cost alternatives to items in his shopping list or in his shopping container, and various other attributes and factors.

In a broad aspect, the disclosed systems and methods enable the user of a device such as a mobile computer, a smartphone, a tablet computer, a smart watch, wearable computers, etc., to more seamlessly accomplish the user's goals at an establishment, and enable the establishment to provide relevant and timely information to the user based on information about the user and other context- and establishment-specific attributes. For example, in a vending environment, such as a grocery store, a department store, or a mall, the user is a shopper, and the device enables the user to efficiently locate items on his shopping list, receive relevant and timely suggestions for other items to purchase, and ultimately, streamlining his checkout and payment process. The disclosed systems and methods enable the store to make such relevant and timely suggestions based on the user's purchase history, current location within the store, and other attributes and factors. Other environments include multi-activity, -event, and/or -facility establishments, such as a theme parks, zoos, fairs, and museums, in which the disclosed systems and methods enable the user of a device to efficiently locate, travel to, and participate in desired activities and events, quickly locate facilities such as restaurants, first aid centers, transportation stops, and bathrooms, and receive suggestions for other activities and events. In such environments, the disclosed systems and methods enable the establishment to make relevant and timely suggestions based on information regarding the user's current location, participation history, and other information, to make announcements regarding establishment-wide events, such as parades, weather emergencies, temporary cancellations, etc., and to identify potential issues related to a particular activity, event, or facility, based on the user's information, including his location.

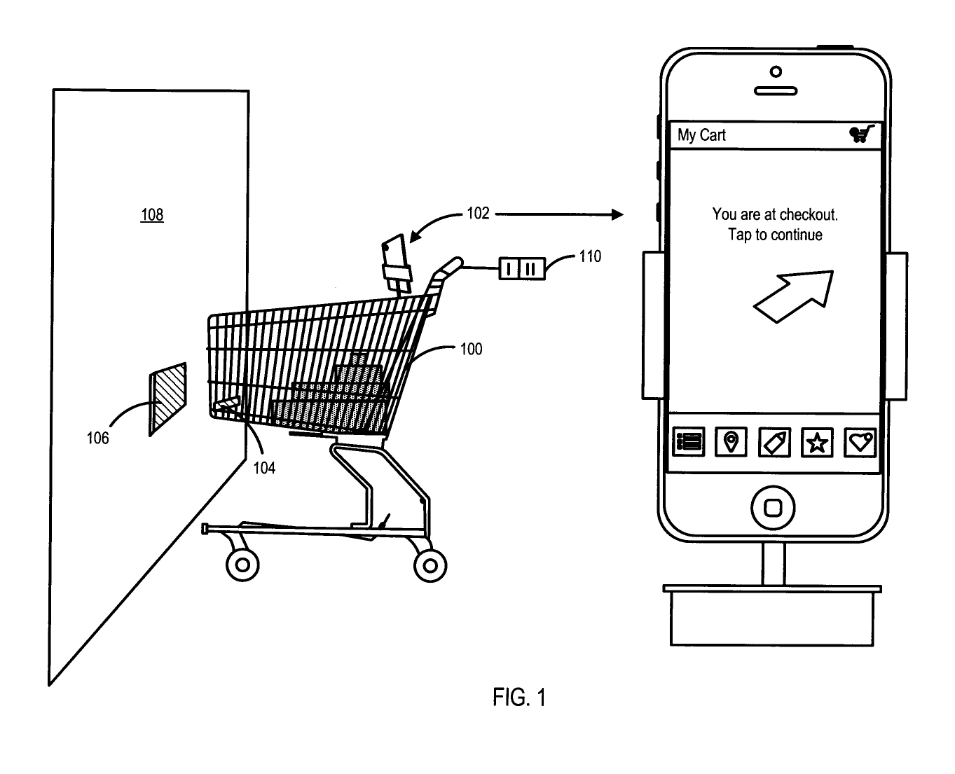

An embodiment of the system provides a device configured to enable a user of the device to locate a desired object or destination at an establishment. Some examples of the device include smart phones, mobile computers, tablet computers, smart watches, and wearable computers, etc. FIG. 1 is an illustration of one embodiment of the system, wherein the device 102 is located near the handle of a shopping cart 100. A desired object includes items that the user wishes to purchase or otherwise acquire. Examples of a destination within an establishment include customer service counter, ticket counter, rest rooms, bakery area, garden area, etc. Examples of a user include shoppers at vending establishments such as grocery stores, and visitors at theme parks, zoos, museums, etc. In some embodiments, the device 102 may be affixed to or incorporated into other equipment provided by the establishment, such as a shopping cart 100, a shopping basket, motorized shopping carts, and other assistive transporting apparatuses.

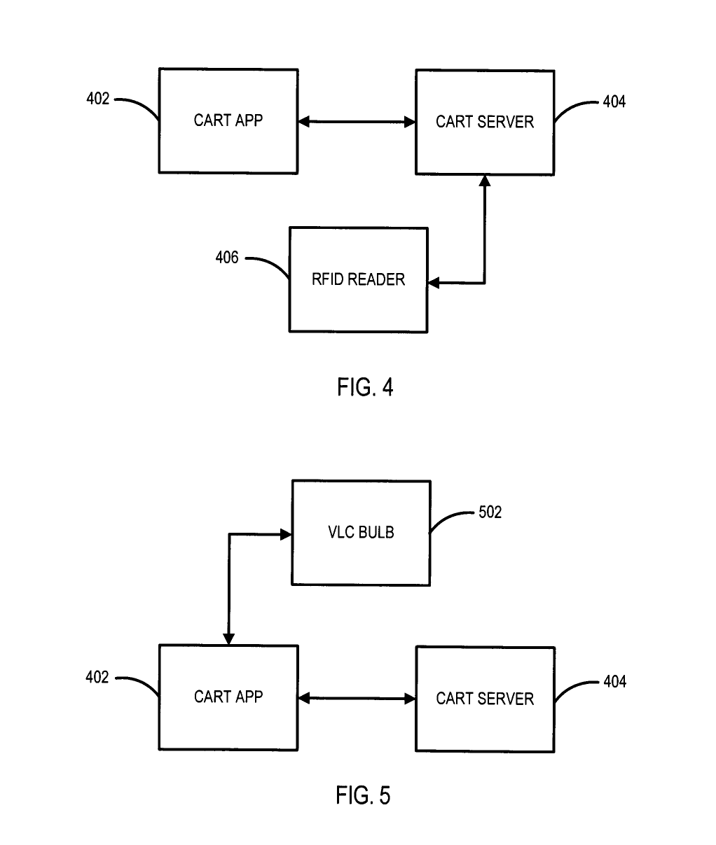

In one aspect, a device is configured to create a list of desired objects or destinations within an establishment. For example, in a vending establishment such as a grocery store, a device may be configured with a shopping cart application (“Cart App”), where the Cart App permits the user to create a shopping list of desired items, to search for items and to view the items found by the search, if any, and to view items suggested by the Cart App. To search for items or to suggest items, the Cart App may access an inventory database. The inventory database may be stored locally on the device with the Cart App, or may be stored in another device associated with a shopping cart server (“Cart Server”). The Cart App may communicate with the Cart Server via a wireless connection, such as Wi-Fi, Bluetooth, NFC, or cellular transmission, and may occur over a public network, such as the Internet, or a private network. FIG. 4. is a diagram of a Cart App 402 in communication with a Cart Server 404. In some embodiments, the Cart App causes the device to transmit a search request or a suggestion request to the Cart Server. The Cart Server, in turn, performs the search request or the suggestion request, respectively, and transmits the resulting items of the request to the Cart App. The Cart App then causes the device to present the resulting items to the user. The user may select any resulting item to add to his shopping list by touching, clicking, or highlighting the area on the device to indicate that the item is to be added to the shopping list.

In some embodiments, the Cart App causes the device to be configured to enable importing items from another source, such as e-mail, text message, blog, web site, other shopping applications, etc., into one of the user's lists. In some embodiments, the device may be configured to enable subscribing to other shopping lists, such as shopping lists based on recipes or shopping lists of other users of the Cart App, and to enable other users to subscribe to the one or more of the user's lists. For example, a user may subscribe to a spouse's shopping list or to their children's shopping lists. According to an embodiment, the user may cause the device to add items from a subscribed shopping list to the list for the current shopping session. In some embodiments, a user may save multiple shopping lists for re-use, and may share his shopping lists via e-mail or social applications.

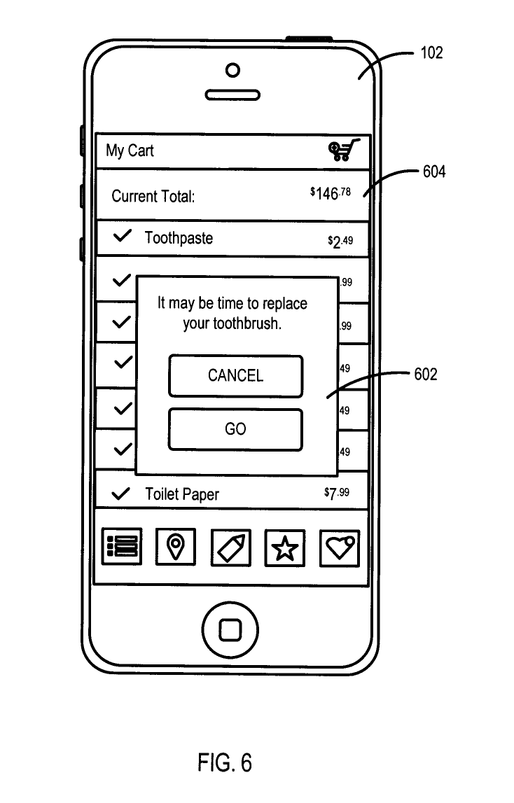

In some embodiments, the Cart App causes the device to present to the user suggested items. FIG. 6 is an illustration of an embodiment wherein suggested items are presented to the user. In an example, the Cart Server may communicate the suggested items to the Cart App. The particular items 602 suggested are based on information such as purchase history, current location of the user in the store, items commonly purchased together with the items in the user's shopping list or shopping cart 604, other Cart App users' recommendations, and alternatives to items in the user's shopping list or shopping cart.

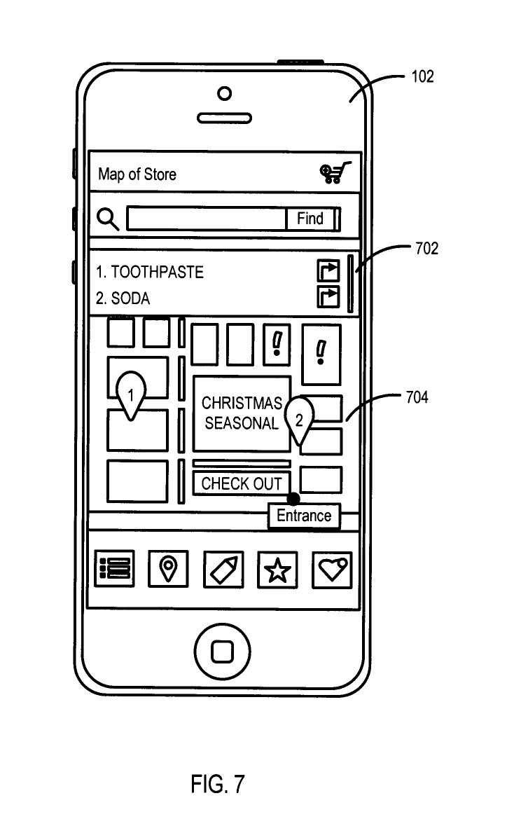

The Cart App enables a user of the device to request the location of any of the items on the shopping list, the items found by the search, or the suggested items. FIG. 7 is an illustration of an embodiment that enables a user to locate one or more items. The user may select one or more items to locate by, for example, touching, clicking, or highlighting the one or more items 702 on the device 102. The Cart App may locate the items by accessing a location database containing items and their location information, and may then cause the device 102 to present to the user the approximate location of the requested one or more items in a graphical map format, with one or more markers representing the location(s) of each of the one or more items, and the map representing features of the store 704. The approximate location may be presented to the user in a plain text format, for example, as simply the aisle number in the store where the item is located, or in an audible format. According to some embodiments, the Cart App may arrange the items in the shopping list in order to optimize the efficiency of the shopping trip. The location database may be stored locally on the device with the Cart App, or may be stored in another device associated with the Cart Server. In some embodiments, the Cart Server may be remote, and the communication with the Cart Server may occur via the Internet, a metropolitan area network, a wide area network, a private network, or any network permitting such communications. See also FIG. 4. The Cart App 402 may communicate with the Cart Server 404 via a wireless connection, such as Wi-Fi, Bluetooth, NFC, or cellular transmission, and may transmit the selected one or more items 702 to the Cart Server, which in turn locates the one or more items in the location database, and transmits the location information to the Cart App 402, causing the device 102 to present the information to the user in graphical 704, plain text, and/or audio formats.

In some embodiments, for each item to be located, if the item information in the inventory database indicates that no such item remains at the store, the Cart Server will indicate to the Cart App that the item is unavailable. The Cart App may, in turn, cause the device to display an unavailable marker for each such unavailable item on the map. The Cart Server may also identify alternatives to the unavailable item, and transmit the alternatives information, along with the location information, to the Cart App. The Cart App may cause the device to indicate the unavailability of an item, and to present to the user the identified alternatives for adding to the shopping list and/or to locate the alternatives.

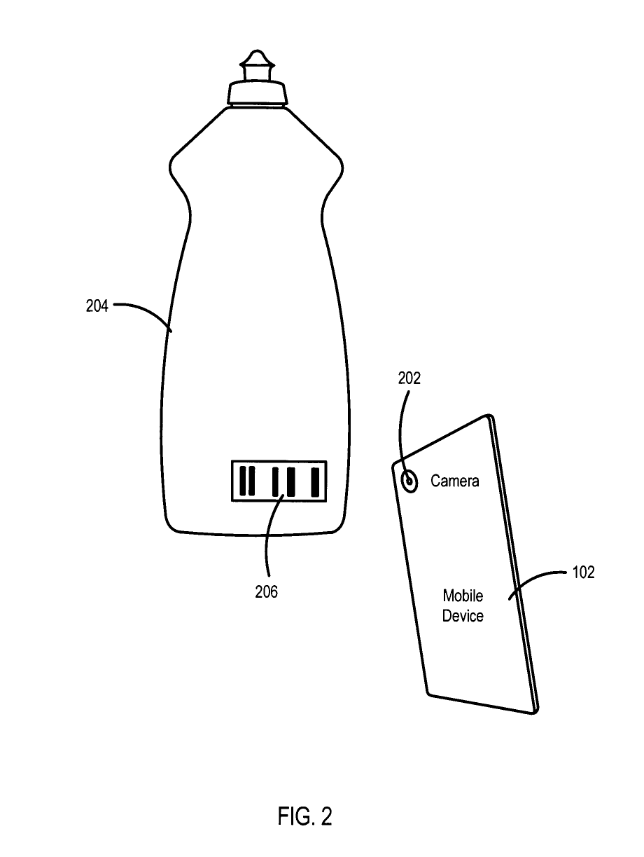

In one embodiment, the device is configured to enable the user of the device to register a desired object at the establishment. The device may include at least one of a digital camera, a barcode reader, an NFC component, an RFID reader, etc. FIG. 2 is a diagram of an embodiment of the device 102, including a digital camera 202, and a desired object 204 having a bar code 206. In reference to both FIG. 1 and FIG. 2, the device 102 may be a user-supplied device, or may be a device affixed to the shopping container 100. The device 102 may be affixed in various locations, such as near the handle, or at another location on the shopping container 100. Moreover, the digital camera 202, barcode reader, NFC component, RFID reader, etc., of the device 102, may be affixed to the shopping container 100 at a location different from location of the device 102, and may be configured to communicate to the device 102. In an operational example, a shopper at a vending establishment may remove a desired item 204 from a shelf, register the item with the device, and place the item into a shopping container 100, such as a shopping cart or basket. In an embodiment, registering the item may involve using the Cart App to cause the device's digital camera 202 to decode the item's identifying information, such as a bar code 206. In other embodiments, registering an item involves using the Cart App to cause the device's NFC component or its RFID reader to obtain information from an NFC- or RFID-enabled item, and to register that item. Registering an item causes the Cart App to add the item to the list of items currently in the shopping cart. In some embodiments, the device is configured to enable the user to “cross off” the item just registered from his shopping list to keep track of items remaining to be placed in the cart. In some embodiments, registering an item may cause the Cart App to automatically “cross off” the item on a shopping list. The device is configured to enable the Cart App to maintain a running total cost of the items registered and placed in the cart. The Cart App enables the user to cause the device to display running total at any time. The device may be further configured to account for items removed from the cart wherein, upon removal from the cart, an item is de-registered by the user from the Cart App, and the cost is subtracted from the total. In an embodiment, the Cart App enables the user to adjust the quantity of any items at any time, whether the items are registered or are in a list, such as a shopping list.

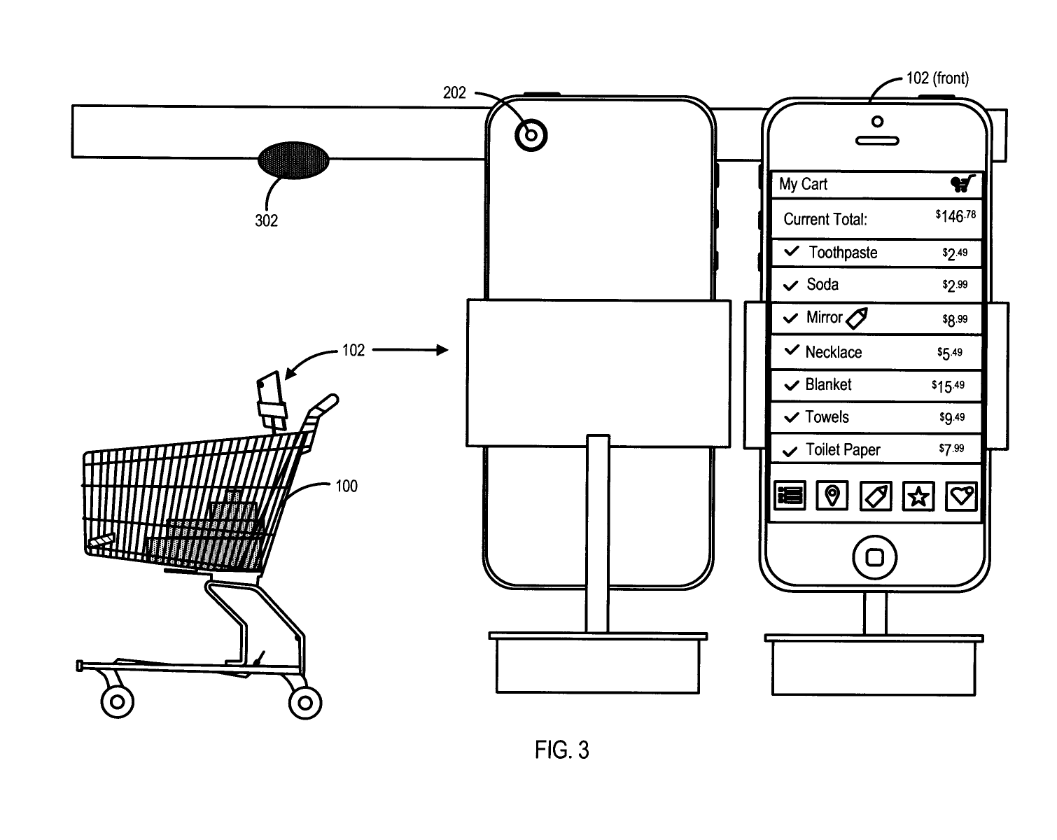

In some embodiments, the current location of the user within the establishment is determined. In one embodiment, the Cart App causes the device to activate the device's global position system (GPS) feature. GPS, which is currently useful in distances longer than 7.8 meters, may not be precise enough to determine smaller distances found in some establishments. FIG. 3 is an illustration of, and FIG. 5 is a diagram of, another embodiment of the system. In that embodiment, the Cart App causes the device 102 to activate its optical sensor or image capture mechanism, such as a digital camera, and a nearby light bulb 302, 502 transmits the bulb's identification to the device's camera using visible light communications (VLC). The Cart App 402 determines the location of the device (and thus the user of the device) by accessing the bulb location database. The bulb location database may be stored locally on the device with the Cart App 402, or may be stored on another device associated with the Cart Server 404, and the Cart App 402 may, via the user's device, communicate wirelessly with the Cart Server 404. As the user moves throughout the establishment, the user's device 102 detects VLC from a different nearby bulb 302, 502, and the Cart App 402 determines his new location. In some embodiments, suggested items are identified for purchase, the suggestions based on the current location of the user. For example, a suggestion may be made to a user walking about the frozen dinner section to not forget dessert, suggesting a particular frozen treat on sale. FIG. 6 is an illustration of some embodiments in which suggested items 602 may be based on, in addition to the shopper's location, items on the shopping list 604, and/or items on the shopping list that are related to the suggested items by a recipe. Suggested items may be further based on a shopper's buying history, or a shopping list that the buyer has subscribed to.

According to some embodiments, the current location of the user may be determined using RFID tags and readers. FIG. 1 is an illustration, and FIG. 4 is a diagram, of some of those embodiments. A unique barcode 110 and RFID tag 104 is affixed to each shopping container 100, such as a shopping cart or basket, and the barcode 110 and RFID tag 104 information associated with each container 100 is stored in a shopping container database. In some embodiments, the barcode 110 may be located near the handle of a shopping cart 100. The container database is stored on a device associated with the Cart Server. RFID readers 106, 406 may be affixed to strategic locations throughout the establishment on mostly permanent structures 108 such as shelves, support beams, counters, etc. Each RFID reader 106, 406 is in constant communication with the Cart Server 404, either wired or wirelessly. A user pairs his device 102 to the container 100 by using the Cart App 402 to cause the device 102 to scan the barcode 110, and to transmit the pairing information to the Cart Server 404. The transmission to the Cart Server 404 is wireless, and the Cart Server 404 stores the received pairing information in the shopping container database. In the example of a shopping cart, when the cart is within the range to be identified, the RFID reader 106, 406 reads the RFID tag 104 on the cart, and transmits the cart's tag information to the Cart Server 404. Using the information in the shopping container database, the current location of the cart 100 (and likely the user) is determined, i.e. near the particular RFID reader 106, 406 that read the RFID tag 104.

In other embodiments, the current location of the user may be determined using RFID tags and readers, where a RFID reader 406 is affixed to each shopping container and RFID tags are affixed to strategic locations throughout the establishment on mostly permanent structures. The RFID reader 406 is in communication with the Cart Server 404, and is further in communication with the device. In some embodiments, the device 102 may be a user-supplied device, while in others, the device 102 may be supplied by the establishment, and may be affixed to the shopping container. The communication between the RFID reader 406 and the device 102 may be wired or wireless. Wireless communications include communications via Wi-Fi, Bluetooth, NFC, etc. In some cases, the RFID reader 406 may be a built-in to the device or the shopping container.

In many embodiments, the device is configured to determine and present on the device's display directions from the current location of the user to the desired objects or destinations. FIG. 7 is an illustration of some aspects of those embodiments. In a grocery store example, the Cart App enables the user to use his device to request directions from his current location in the store to a selected shopping list item. The Cart App wirelessly transmits the request for directions to the Cart Server, and the Cart Server, after calculating the route and determining the directions, transmits the route and directions to the Cart App. The Cart App may present the directions in a graphical map format, a plain text format, or an audio format. Similarly, in a shopping mall example, the Cart App enables the user to use his device to request directions to the nearest rest room or shoe store.

In the example of a museum or a zoo, the Cart App enables the user to browse available activities and exhibits, and to request directions to a desired activity or exhibit. Other examples include directions to special time-limited sales, sampling of merchandise, kids play areas, checkout area, deli section, hardware section, frozen section, gardening section, in-store vendors, such as banks, etc. In one embodiment, the user may select from a list of items, and request the shortest route to obtain all of the selected items. The shortest route may be useful to those in a hurry, those trying to avoid impulse buying, and those who physically necessitate the most direct route. In an example involving a theme park, a user may select a few activities to participate in for a given day, and the system may determine an ideal sequence of those activities, accounting for information such as the busiest times for each activity, and distance between activities, mode of travel available, and duration of such travel. In one embodiment, such sequence is updated in real time to reflect changing conditions during the day.

Some embodiments are directed to further processing between devices and objects. In one embodiment, RFID readers and/or barcode scanners facilitate the checkout process at a vending establishment. In an example, a shopper has paired his device to a shopping cart. The shopper used his device to register each item placed into his shopping container, and is ready to checkout. The shopping cart is placed in a checkout bay, and the user indicates to the Cart App that he is ready to checkout. The Cart App requests that user confirm his request, and upon the user's confirmation, requests the user to compare the items in the cart with the items registered into the Cart App. The user may use the Cart App and his device to register any items in the cart that have not been registered. When ready, the user repeats his checkout request, and proceeds to confirm that all items have been registered.

In some embodiments, the items are further verified by weighing after the user has confirmed the items. Upon confirmation of the items, the Cart App causes the device to transmit the list of confirmed items to the Cart Server, which stores the items in a shopping session database. At the checkout bay, an RFID reader or a barcode scanner identifies the particular cart, and weighs the cart. The cart identification and its checkout weight are transmitted, via wire or wirelessly, to the Cart Server, which stores the checkout weight in the shopping container database. The Cart Server obtains the difference between the empty weight of the particular cart and the checkout weight (Weight Difference), and compares the Weight Difference with the sum of the known weights of the user-confirmed items stored in the shopping session database. The known weights of each item are obtained from the inventory database. If the sum of the known weights of the confirmed items is less than the Weight Difference beyond a pre-determined threshold, the Cart App provides the user options to re-confirm the items or to request assistance from the store's personnel.

In some embodiments, the items are further verified by item detectors and sensors after the user has confirmed the items. Upon confirmation of the items, the Cart App causes the device to transmit the list of confirmed items to the Cart Server, which stores the items in a shopping session database. In this example, the shopper has earlier paired his device with the cart, and at the checkout bay, an RFID reader or a barcode scanner identifies the particular cart. The cart identification is transmitted to the Cart Server, which uses that information to identify the user device paired to the cart in the shopping container database. The item detectors and sensors include barcode readers, RFID readers, and cameras, and may be automatically or manually operated to detect or sense each item in the cart. In the embodiment using RFID readers, each item can be uniquely identified by the item's RFID tag. Preferably, the items remain in the cart, with minimal manipulation required for detection. The detectors and sensors transmit the detected-items information to the Cart Server, which in turn, transmits that information to the Cart App on the user's device. At this point, the user may, if necessary, reconcile any differences between the confirmed items and the detected items. If any adjustments cause the adjusted total cost to be less than the total cost before adjustment, and the difference between the two costs is greater than a pre-determined threshold, the Cart App provides the user options to re-adjust the items or to request assistance from the store's personnel.

In an embodiment, the device is configured to facilitate transaction processing between the user's device and a point-of-sale system. After successfully confirming the purchased items, the user may provide payment information electronically via the Cart App, using electronic wallets, stored payment profiles, NFC, electronic check, and payment processors such as PayPal. Upon successful payment, the Cart App presents the user with an electronic receipt along with an option to print a hardcopy of the receipt. If the hardcopy is requested, a receipt printer, located at the checkout bay and in communications with the Cart Server, provides the hardcopy to the user. Alternatively, payment information may be provided at a physical point-of-sale cashier station. The cashier station may be configured to be in communication with the Cart Server.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above systems, constructions, devices, and methods without departing from the scope of aspects of the invention, it is intended that all matter contained in the above description and shown in the accompanying drawings shall be interpreted as illustrative and not in a limiting sense.

1. A system for communication and processing between devices and objects, the system comprising:
at least one processor;
a memory; and
at least one list, wherein:
the at least one list comprises a plurality of entries;
the entries of each list are references to objects; and
the at least one list is stored in the memory; and
a list module executable with the at least one processor, wherein the list module is configured to manage the at least one list.

2. The system of claim 1 wherein the management of the at least one list comprises:
creating a new list;
revising a list;
deleting a list;
importing a list;
sharing a list; and
subscribing to a list.

3. The system of claim 2 wherein a list to which a user is enabled to subscribe is another user's list.

4. The system of claim 2 further comprising a quantity attribute associated with each entry of a list, wherein the list module further enables a user to update each entry's quantity attribute.

5. The system of claim 2 further comprising a status attribute associated with each entry of a list wherein:
the list module is further configured to update the status of an entry; and
the status of an entry is selected from a group comprising: in-cart and still-needed.

6. The system of claim 5 wherein the list module is further configured to receive information about objects physically present in an establishment.

7. The system of claim 6 wherein the list module is configured to receive the information via an optical device.

8. The system of claim 7 wherein the information is encoded in an image acquirable by the optical device, wherein the image is selected from a group comprising: a barcode and a QR code.

9. The system of claim 6 wherein the list module is further configured to receive the information via a wireless signal, wherein the type of wireless signal is selected from a group comprising: near field communication (NFC), radio frequency identification (RFID), Wi-Fi, and Bluetooth.

10. The system of claim 6 wherein the list module is further configured to automatically update the status of an entry based on the received information.

11. The system of claim 5 further comprising a total dollar amount reflecting the sum of the cost of all list entries having an in-cart status, wherein the list module is further configured to update the total dollar amount based on a status update of a list entry.

12. The system of claim 5 wherein the list module enables a user to update the status of a list entry as in-cart or still-need.

13. The system of claim 12 further comprising:
a checkout module executable on the at least one processor; and
a checkout bay comprising at least one object detector, wherein the bay is configured to:
enable association with a shopping container;
enable detection of individual objects in the shopping container;
communicate to the checkout module;
wherein the checkout module is configured to:
present to the user the list of objects having an in-cart status, the price of each such object, and the total cost of the objects that have an in-cart status;
receive from the checkout bay a list of detected objects;
identify discrepancies between the list of objects having an in-cart status and the list of detected objects;
present any discrepancies to the user; and
receive from the user any adjustments to the list of objects having an in-cart status.

14. The system of claim 13 wherein the checkout module is further configured to receive payment via a user's device, wherein the method of payment received is selected from the group comprising: electronic wallet, stored payment profile, NFC, electronic check, and payment processors.

15. The system of claim 13 wherein the type of the at least one object detector is selected from the group comprising: RFID reader, barcode scanner, and digital image sensor.

16. The system of claim 1 further comprising:
an inventory database stored in the memory, wherein the database comprises information about objects related to an establishment;
a search module executable with the at least one processor, wherein the search module is configured to search the inventory database for the information about the objects; and
a results list of entries comprising references to those objects found by the search, wherein the list module is further configured to present the results list.

17. The system of claim 16 further comprising search criteria supplied by a user, wherein the search of the inventory database is based on the user-supplied search criteria.

18. The system of claim 17 wherein the user-supplied criteria comprises an entry from the at least one list.

19. The system of claim 16 further comprising pre-determined search criteria wherein:
the search criteria is stored in the memory; and
the search of the inventory is based on the pre-determined search criteria.

20. The system of claim 19 wherein the pre-determined criteria may be based in part on at least one of: a user's purchase history, a user's location within the establishment, a user's list of objects, a user's friends' recommendations, and other objects related to objects in a user's list.

21. The system of claim 16 wherein:
the inventory database further comprises location information for each object;
the results list further comprises the location information for each entry in the results list; and
the list module is further configured to present the location information for each entry in the results list.

22. The system of claim 21 wherein the list module is configured to present the location information graphically.

23. A system for communication and processing between devices and objects, the system comprising:
at least one processor;
a memory;
a pairing module executable by the at least one processor, wherein the pairing module is configured to:
receive an identification of a user's device;
receive a first identification of a shopping container;
receive, via the user's device, a second identification of the shopping container;
create an association between the identification of the user's device with the shopping container; and
store in the memory the identification of the user's device, the two identifications of the shopping container, and the association.

24. The system of claim 23 further comprising a radio frequency identification (RFID) reader, and an RFID tag, wherein
the RFID tag is affixed to the shopping container, and is configured to transmit the first identification; and
the RFID reader is configured to:
receive the first identification transmitted by the RFID tag when the tag is in range; and
communicate with the pairing module.

25. The system of claim 24 wherein the RFID reader is configured to communicate wirelessly with the pairing module.

26. The system of claim 24 further comprising a barcode affixed to the shopping container, wherein
the second identification is encoded in the barcode; and
the second identification is acquired by an optical component of the user's device.

27. The system of claim 26 further comprising a plurality of RFID readers located throughout an establishment, wherein:
each RFID reader is configured to:
read information associated with the RFID tag affixed to the shopping container when the tag is in range; and
communicate with the pairing module; and
the pairing module is configured to:
receive the RFID tag information from the plurality of RFID readers; and
determine the approximate location of the user's device based on:
the locations of the plurality of RFID readers from which the RFID tag information was received; and
the received RFID tag information.

28. A system for communication and processing between devices and objects, the system comprising:
at least one processor;
a memory configured to store location information received from a user's device; and
a user location module executable by the at least one processor, wherein the location module is configured to determine the approximate location of the user's device based on the received location information.

29. The system of claim 28 wherein the location information received comprises global positioning system (GPS) information received from the user's device.

30. The system of claim 28 wherein the location information received comprises visible light communications (VLC) information received from the user's device.

31. The system of claim 28 further comprising:
a plurality of RFID readers located throughout an establishment, wherein:
each RFID reader is configured to:
read information associated with an RFID tag affixed to a shopping container when the tag is in range; and
communicate with the user location module; and
the user location module is configured to:
receive RFID tag information from the plurality of RFID readers; and
determine the approximate location of the user based on:
the locations of the plurality of RFID readers from which the RFID tag information was received;
the received RFID tag information.

32. The system of claim 28 further comprising:
an inventory database stored in the memory, wherein the database contains information about objects related to an establishment; and
a suggestions module executable on the at least one processor, wherein:
the suggestions module is configured to search the inventory database for objects; and
the search for objects is based in part on the approximate location of the user's device within the establishment.

33. The system of claim 28 further comprising:
an inventory database stored in the memory, wherein the database comprises:
information about objects related to an establishment; and
location information for each object in the database;
wherein the user location module is further configured to
receive a list of object entries;
retrieve the location information from the inventory database for the object entries; and
present the location information for each of the object entries.

34. The system of claim 33 wherein the user location module is further configured to:
determine the navigation directions to the location of each of the object entries starting from the determined approximate location of the user's device; and
present the navigation directions.

35. The system of claim 33 wherein the user location module is further configured to:
determine a navigation route starting from the determined approximate location of the user's device to the locations of each of the objects in series; and
present the navigation route.

36. A method for communication and processing between devices and objects, the method comprising:
providing:
at least one processor;
a memory; and
at least one list, wherein:
each list comprises entries;
the entries are references to objects; and
the at least one list is stored in the memory;
configuring the at least one processor to manage the at least one list.

37. The method of claim 36 wherein the managing the at least one list comprises configuring the at least one processor to:
create a new list;
revise a list;
delete a list;
import a list;
share a list; and
subscribe to a list.

38. The method of claim 37 further comprising configuring the at least one processor to subscribe to another user's list.

39. The method of claim 37 further comprising:
providing a quantity attribute associated with each entry of a list; and
configuring the at least one processor to update each entry's quantity attribute.

40. The method of claim 37 further comprising:
providing a status attribute associated with each entry of a list; and
configuring the at least one processor to update the status of an entry, wherein the status of an entry is selected from a group comprising: in-cart and still-needed.

41. The method of claim 40 further comprising configuring the at least one processor to receive information about objects physically present in an establishment.

42. The method of claim 41 further comprising configuring the at least one processor to receive the information via an optical device.

43. The method of claim 42 wherein the information is encoded in an image acquirable by the optical device, wherein the image is selected from a group comprising: a barcode and a QR code.

44. The method of claim 41 further comprising configuring the at least one processor to receive the information via a wireless signal, wherein the type of wireless signal is selected from a group comprising: near field communication (NFC), radio frequency identification (RFID), Wi Fi, and Bluetooth.

45. The method of claim 41 further comprising configuring the at least one processor to automatically update the status of an entry based on the received information.

46. The method of claim 40 further comprising:
determining a total dollar amount reflecting the sum of the cost of all object entries having an in-cart status; and
configuring the at least one processor to update the total dollar amount based on a status update of a list entry.

47. The method of claim 40 further comprising:
providing a checkout bay comprising at least one object detector; and
configuring the at least one processor to:
associate the bay with a shopping container;
detect each of the objects in the shopping container;
present to the user the list of objects having an in-cart status, the price of each such object, and the total cost of the objects that have an in-cart status;
receive from the checkout bay a list of detected objects;
identify discrepancies between the list of objects having an in-cart status and the list of detected objects;
present any discrepancies to the user; and
receive from the user any adjustments to the list of objects having an in-cart status.

48. The method of claim 47 further comprising configuring the at least one processor to receive payment via a user's device, wherein the method of payment received is selected from the group comprising: electronic wallet, stored payment profile, NFC, electronic check, and payment processors.

49. The method of claim 47 wherein the type of the at least one object detector is selected from the group comprising: RFID, barcode scanner, and digital image sensors.

50. The method of claim 36 further comprising:
providing an inventory database stored in the memory, wherein the database comprises information about objects related to an establishment;
configuring the at least one processor to search the inventory database for the information about the object; and
configuring the at least one processor to present a results list, wherein the results list comprises references to those objects found by the search.

51. The method of claim 50 further comprising:
providing search criteria supplied by a user;
configuring the at least one processor to search the inventory database based on the user-supplied search criteria.

52. The method of claim 51 wherein the user-supplied criteria comprises at least one entry from the at least one list.

53. The method of claim 50 further comprising:
providing pre-determined search criteria stored in the memory;
configuring the at least one processor to search for objects based on the pre-determined search criteria.

54. The method of claim 53 wherein the pre-determined criteria may be based in part on at least one of: a user's purchase history, a user's location within the establishment, a user's list of objects, a user's friends' recommendations, and other objects related to objects in a user's list.

55. The method of claim 50 further comprising configuring the at least one processor to present the location information for each entry in the results list, wherein:
the inventory database further comprises location information for each object;
the results list further comprises the location information for each entry in the results list.

56. The method of claim 55 further comprising configuring the at least one processor to present the location information graphically.

57. A method for communication and processing between devices and objects, the method comprising:
providing at least one processor, and a memory;
configuring the at least one processor to
receive an identification of a user's device;
receive a first identification of a shopping container;
receive, via the user's device, a second identification of the shopping container;
create an association between the identification of the user's device with the shopping container; and
store in the memory the identification of the user's device, the two identifications of the shopping container, and the association.

58. The method of claim 57 further comprising:
providing a radio frequency identification (RFID) reader;
providing an RFID tag affixed to the shopping container;
configuring the RFID tag to transmit the first identification; and
configuring the RFID reader to:
receive the first identification transmitted by the RFID tag when the tag is in range; and
communicate with the at least one processor.

59. The method of claim 58 further comprising configuring the RFID reader to communicate wirelessly with the at least one processor.

60. The method of claim 58 further comprising:
providing a barcode affixed to the shopping container, wherein the second identification is encoded in the barcode; and
acquiring the second identification by an optical component of the user's device before the second identification is received by the at least one processor.

61. The method of claim 60 further comprising:
providing a plurality of RFID readers located throughout an establishment;
configuring each RFID reader to:
read information associated with the RFID tag affixed to the shopping container when the tag is in range; and
communicate with the at least one processor;
configuring the at least one processor to receive RFID tag information from the plurality of RFID readers;
configuring the at least one processor to determine the approximate location of the user's device based on:
the locations of the plurality of RFID readers from which the RFID tag information was received; and
the received RFID tag information.

62. A method for communication and processing between devices and objects, the method comprising:
providing at least one processor;
providing a memory;
storing location information received from a user's device in the memory; and
configuring the at least one processor to determine the approximate location of the user based on the received location information.

63. The method of claim 62 further comprising configuring the at least one processor to receive global positioning system (GPS) information via a user's device.

64. The method of claim 62 further comprising configuring the at least one processor to receive visible light communications (VLC) information via a user's device.

65. The method of claim 62 further comprising:
providing a plurality of RFID readers located throughout an establishment;
configuring each RFID reader to:
read information transmitted by an RFID tag affixed to a shopping container when the tag is in range; and
communicate with the at least one processor;
configuring the at least one processor to:
receive RFID tag information from the plurality of RFID readers;
determine the approximate location of the user based on:
the locations of the plurality of RFID readers from which the RFID tag information was received; and
the received RFID tag information.

66. The method of claim 62 further comprising:
providing an inventory database stored in the memory, wherein the database contains information about objects related to an establishment;
configuring the at least one processor to search the inventory database for objects, based in part on the approximate location of the user's device within the establishment.

67. The method of claim 62 further comprising:
providing an inventory database stored in the memory, wherein the database comprises:
information about objects related to an establishment; and
location information for each object in the database;
configuring the at least one processor to:
receive a list of object entries;
retrieve the location information from the inventory database for the object entries; and
present the location information for each of the object entries.

68. The method of claim 67 further comprising configuring the processor to:
determine the navigation directions to the location of each of the object entries starting from the determined approximate location of the user's device; and
present the navigation directions.

69. The method of claim 67 further comprising configuring the at least one processor to:
determine a navigation route starting from the determined approximate location of the user's device to the locations of each of the objects in series; and
present the navigation.
